(19) United States
(12) Patent Application Publication
(10) Pub. No.: US 2012/0067877 A1
(43) Pub. Date: Mar. 22, 2012

(54) COLLAPSIBLE CARRYING DEVICE

(76) Inventor: Shaumil Dave, Batavia, IL (US)

(21) Appl. No.: 12/886,705

(22) Filed: Sep. 21, 2010

(51) Int. Cl. B65D 6/24; B23P 19/04

(52) U.S. Cl. 220/4.33; 29/428

(57) ABSTRACT

A carrying device including a first panel having a first end and a second end, a second panel having a first end and a second end with one end rotatively coupled to one end of the first panel, a third panel having a first end and a second end with one end rotatively coupled to the other end of the second panel, a fourth panel having a first end and a second end with one end rotatively coupled to the other end of the third panel and the other end rotatively coupled to the other end of first panel.

### FIELD OF THE INVENTION

This application relates to carrying devices such as a collapsible carrying device. Specifically, the application relates a carrying case which can be collapsed into more compact structures.

### BACKGROUND OF THE INVENTION

The beverage industry, for example, is full of cardboard, plastic, or fabric devices for carrying solid form objects. Although disposable and recyclable, these devices do not endure stress of the environment nor are they expandable. When exposed to water, for example, cardboard and fabric devices deteriorate and loose their form. When exposed to ice, for example, plastic devices can crack. When dropped or stacked, plastic and cardboard devices can be unstable.

Accordingly, a need exists for a carrying device which can be used multiple times and is collapsible for easy storage and delivery.

### SUMMARY OF THE INVENTION

The present invention provides a carrying device which folds when not in use and which can be manufactured from a variety of materials. In addition, the carrying device of the present invention can withstand warping over time when exposed to the stress of water and cold. Accordingly, environmental issues presented by the use of single use paper carrying devices are reduced because of the ability of such a device to be reused repeatedly.

One embodiment consistent with the present invention includes a carrying device comprising a first panel having a first end and a second end, a second panel having a first end and a second end with one end rotatively coupled to one end of the first panel, a third panel having a first end and a second end with one end rotatively coupled to the other end of the second panel, a fourth panel having a first end and a second end with one end rotatively coupled to the other end of the third panel and the other end rotatively coupled to the other end of first panel.

Another embodiment consistent with the present invention includes a carrying device where a right angle pin connects the first panel to the fourth panel and restricts the rotation of the fourth panel such that an angle between the first panel and fourth panel is between 0 and 90 degrees.

Another embodiment consistent with the present invention includes a straight angle pin that connects the first panel to the second panel and restricts the rotation of the second panel such that an angle between the first panel and second panel is between 90 and 180 degrees.

Another embodiment consistent with the present invention includes a right angle pin that connects the second panel to the third panel and restricts the rotation of the third panel such that an angle between the second panel and third panel is between 0 and 90 degrees.

Another embodiment consistent with the present invention includes a straight angle pin that connects the third panel to the fourth panel and restricts the rotation of the fourth panel such that an angle between the third panel and fourth panel is between 90 and 180 degrees.

Another embodiment consistent with the present invention includes the second, third and fourth panels rotating around the base panel such that the second panel is in the same plane as the first panel and the third and fourth panels are at least on of the first panel and second panel.

Another embodiment consistent with the present invention includes a handle rotatively connected to a top edge of the first panel.

Another embodiment consistent with the present invention includes a guide unit rotatively coupled to a lower portion of the first and a lower portion of the third panel.

Another embodiment consistent with the present invention includes the guide unit including at least two rods which are rotatablly connected to the guide unit.

Another embodiment consistent with the present invention includes the guide unit fitting into a recess in the first, second, third and fourth panels when the carrying device is closed.

Another embodiment consistent with the present invention includes a method of manufacturing a carrying device comprising the steps of rotatively coupling one end of a first panel to one end of a second panel, rotatively coupling the other end of the second panel with one end of a third panel, rotatively coupling the other end of the third panel to one end of a fourth panel; and rotatively coupling the other end of the fourth panel to the other end of the first panel.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts a side perspective view of the bottle carrier which is consistent with the present disclosure.

FIG. 2A depicts one embodiment of the straight pin consistent with the present invention

FIG. 2B depicts one embodiment of the right angle pin consistent with the present invention.

FIG. 2C depicts one embodiment of a side view of the first, second and third panels laid flat which is consistent with the present disclosure

FIG. 3 depicts a top view of a carrying case consistent with the present invention.

FIG. 4A depicts one embodiment of a top view of the bottle carrying including a guidance rod which is device consistent with the present disclosure.

FIG. 4B depicts one embodiment of an end portion of a guidance rod consistent with the present invention.

FIG. 5 depicts one embodiment showing two sides of the carrying device consistent with the present invention.

FIG. 6 depicts one embodiment of a combination of carrying devices consistent with the present invention.

FIG. 7 depicts one embodiment of a combination of carrying devices in a collapsed position consistent with the present invention.

FIG. 8 depicts one embodiment of the process used to make a carrying device consistent with the present invention.

### DETAILED DESCRIPTION OF THE INVENTION

While various embodiments of the present invention are described herein, it will be apparent to those of skill in the art that many more embodiments and implementations are possible that are within the scope of this invention. Accordingly, the present invention is not to be restricted except in light of the attached claims and their equivalents.

As disclosed in further detail herein, a collapsible carrying device for carrying solid form objects. The carrying device has sides that are hinged using an offset pivot such that the side edges remain apart to allow the sides to collapse without interference along the pivots. The objects placed in the device are supported on the bottom by a rod which sits on pivot points to allow it to swivel when the device is collapsed. A channel formed along the bottom edge allows the bottom guidance rod to tuck into the sides when folded flat. A handle is rotated out and up from the side of the device to allow the device to fold flat without any extrusions. In one embodiment consistent with the present invention the device folds in only one direction laterally since the offset pivot points have at least one fixed position, allowing the expanded form to have a predictable and uniform cavity in which to place solid form objects. The lateral fold allows for horizontal storage. Multiple devices may be connected to expand capacity.

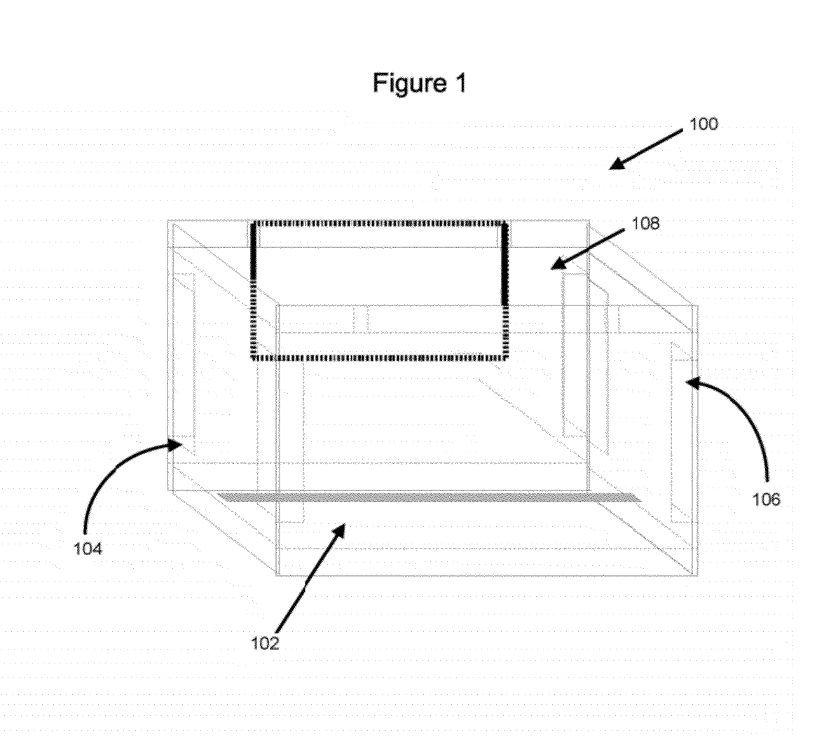

FIG. 1 depicts a side view of the bottle carrying device 100 which is consistent with the present disclosure. In the present embodiment, the bottle carrying device 100 includes a first panel 102 with a first edge pivotally connected to a first edge of a second panel 104 and a second edge located opposite to the first edge which is pivotally connected to a first edge of a third panel 106. The second panel 104 includes a second edge which is opposite to the first edge and is pivotally connected to the first edge of a base panel 108. The third side 106 also has a second edge located opposite to the first edge which is pivotally connected to a second edge of the base 108.

The bottle carrier is configured such that the first panel 102, second panel 104 and third panel 106 rotate counter-clockwise around the base panel 108 such that the third panel 106 is covered by the first panel 102 and the second panel 104 is in contact with the base panel 108 when the bottle carrying device 100 is compacted. In addition, when in the open position, the first panel 102 is opposite the base panel 108 and perpendicular to the second panel 104 and third panel 106. The panels are made from a rigid material such as, but not limited to, steel, aluminum, wood or any other rigid material capable of withstanding the rotational force applied to the panels in the open and closed position. Further, the type of material used will determine the thickness of the material.

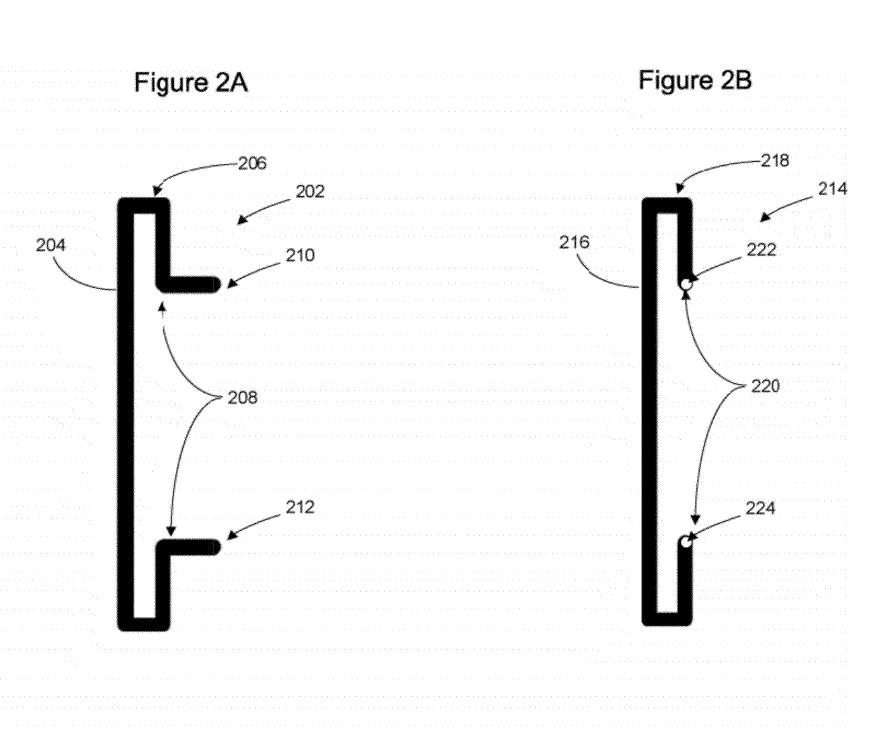

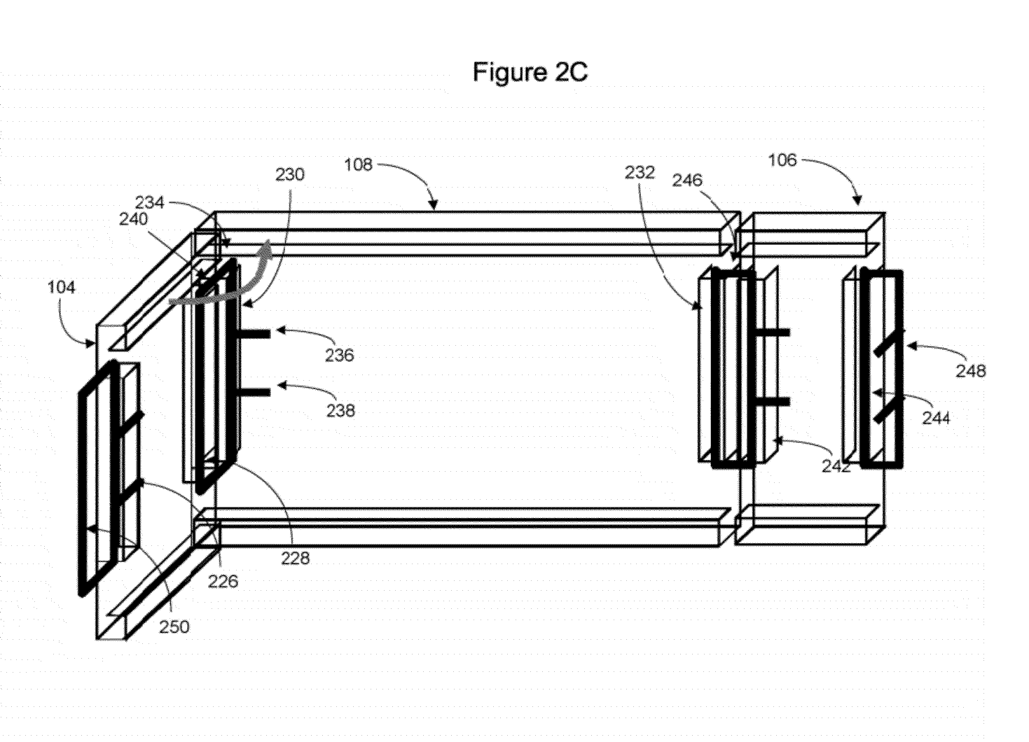

FIG. 2A depicts one embodiment of a straight pin consistent with the present invention. The straight pin 202 includes a back portion 204, an offset portion 206 and an open portion 208. The open portion 208 includes two rods 210 and 212 which extend from the open portion 208. The operation and configuration of the straight pin as it relates to the bottle carrier will be discussed later. The straight pin 202 may be made of metal, plastic, cardboard or any other material which can hold its shape when a rotational force is applied.

FIG. 2B depicts one embodiment of a right angle pin 214. The right angle pin 214 includes a back portion 216, an offset portion 218 and an open portion 220. The open portion 220 includes two rods 222 and 224 which extend from the open portion and are angled ninety degrees from the plane of the open portion 218. The operation and configuration of the right angle pin as it relates to the bottle carrier will be discussed later. The right angle pin 214 may be made of metal, plastic, cardboard or any other material which can hold its shape when a rotational force is applied.

In FIGS. 2A and 2C, the sizes of the offset portions 206 and 218 of each pin are set to a minimum distance “o” where o is defined by the equation. o=0.5 (r+d) and r is the radius of the pin (herein called pin radius) and d is the thickness of the material of used to make the panels.

FIG. 2C depicts a perspective view of the first, second and third panels connected with both right angle pins and straight pins. The second panel 104 includes two channels 226 and 228 formed on opposing sides of the panel 104. The base panel 108 also includes two channels 230 and 232 formed on opposing sides of the base panel 108. Panels 104 and 108 are connected by a right angle pin 234 whose back portion is inserted into channels 228 and whose open portion is inserted into channel 230. As the figure depicts, the right angle pin 234 rotatively connects panel 104 and panel 108. The two rods 236 and 238 are positioned at a substantially 90 degree angle from the panel 104 and the offset portion, back portion and open portion of the right angle pin are all parallel to the panel 104. The panel 104 rotates around the back portion of the right angle pin 234. However, because of the rods 236 and 238, the panel 104 can only rotate towards the base panel 108 and to a position substantially perpendicular to the base panel 108.

The third panel 106 is also rotatively coupled to the base panel 108. The third panel 106 also includes two channels 242 and 244 on opposite facing ends on the panel 106. The third panel 106 is rotatively coupled to the base panel 108 by a straight pin 246. The back portion of the straight pin 246 is inserted into the channel 232 on the base panel 108 and the open portion of the straight pin 246 is inserted into the channel 242. The third panel 106 rotates around the channel 232 on the base panel 108. Because of the arrangement of the rods on the straight pins, the third panel 106 can only rotate a 90 degrees in relation to the base panel.

The first panel 102 also includes two channels 252 and 254 located at opposing sides of the first panel 102. The first panel 102 is rotatively coupled to the second panel 104 by straight pin 250 and to panel 106 using right angle pin 248 which both are inserted into the channels on panel 102.

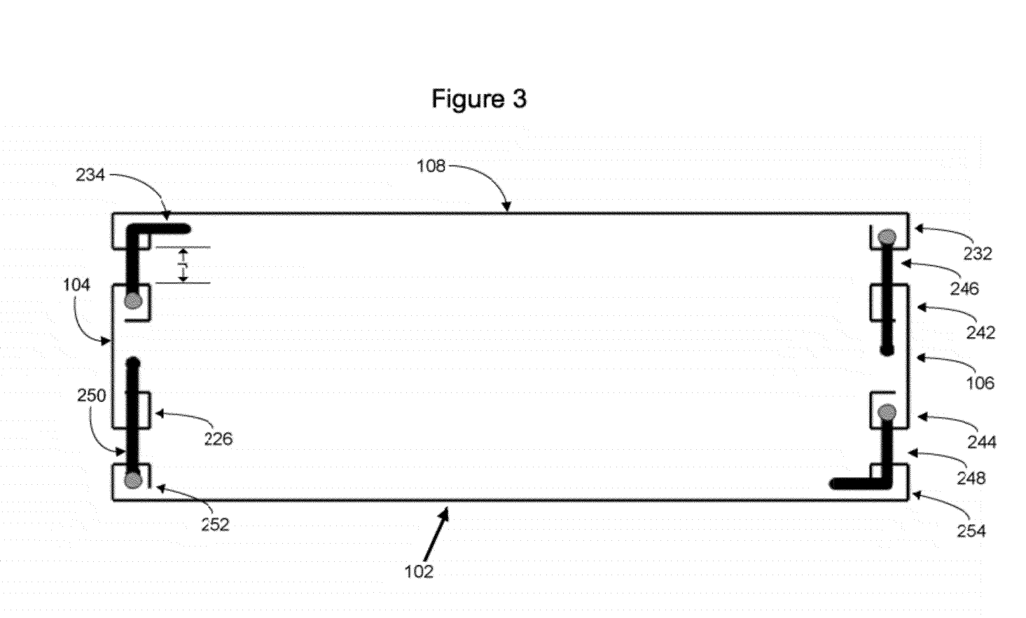

FIG. 3 depicts a top view of one embodiment of the bottle carrying device 100 consistent with the present invention. As the figure depicts, the second panel 104 is connected to base panel 108 using right pin 234, panel 108 is connected to third panel 106 by straight pin 246, third panel 106 is connected to panel 102 using right angle pin 248 and panel 102 is connected to second panel 104 by straight pin 250. Under this configuration, an angle between the base panel 108 and second panel 104 is limited to a value between approximately 90 and 0 degrees. An angle between panels 104 and 102 is limited to a value between approximately 90 and 180 degrees. An angle between panels 108 and 106 is limited to a value between approximately 90 and 180 degrees. An angle between panels 102 and 106 is limited to a value between approximately 90 and 180 degrees. Therefore, the carrier is limited to rotation in one direction.

In another embodiment consistent with the present invention, a gap of a predetermined distance r is created between the panels. The gap is calculated to allow the panels to rotate such that the panels do not interfere with one another during rotation. Further, the gap is calculated to allow the panels 102, 104 and 106 to lay completely flat when the carrier is in the closed position. In another embodiment consistent with the present invention, the distance r is determined based on the size or weight of the carrier device. In another embodiment consistent with the present invention, the gap distance r is based on the thickness of at least one straight or right angled pin. Consistent with this embodiment, the gap between any two panels is defined by the equation 0.5*(r+d), where r is the radius of the right angle pin and the straight pin while d is the thickness of the material used to make the panels.

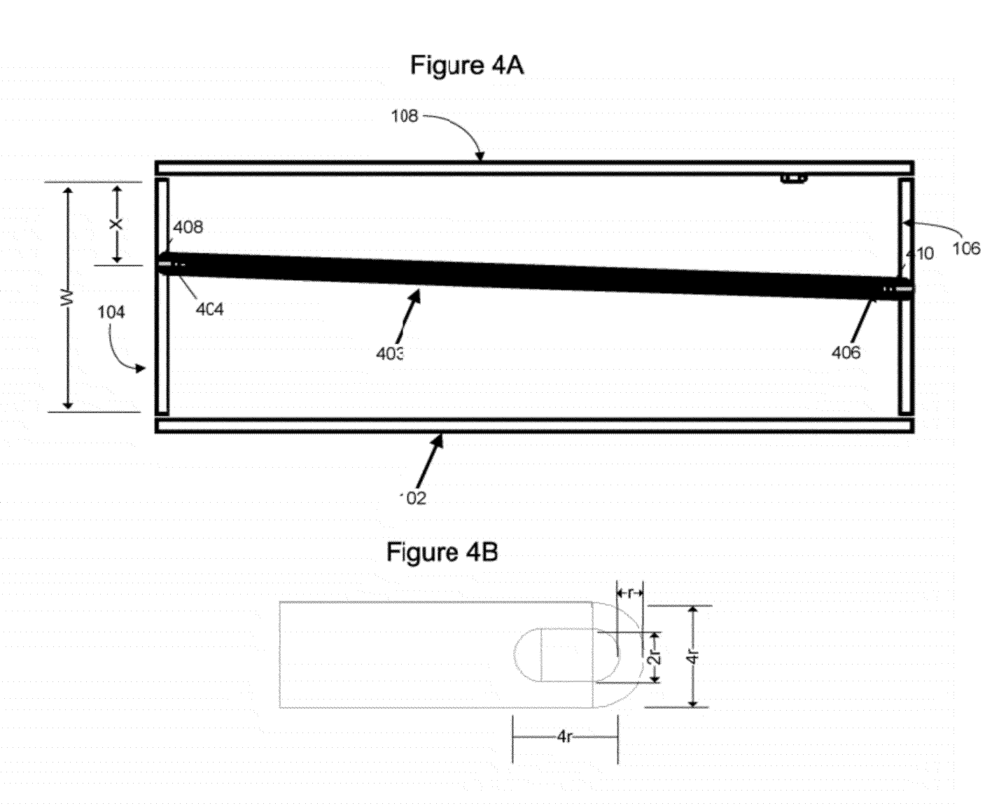

FIG. 4A depicts a top view of one embodiment of the bottle carrying device consistent with the present disclosure. In this embodiment, the panels 102, 104, 106 and 108 are connected as disclosed above. An additional guidance rod 403 is attached to the lower portion of panels 104 and 106 at a predetermined position. The guidance rod 403 acts to smooth the rotation of the panels as they rotate from the open to the closed position.

In another embodiment consistent with the present invention, the guidance rod 403 acts to lock the panels into place when the carrier is in the open position. The guidance rod 403 may lock the carrier into the open position by engaging a locking pin located at the bottom portion of the panel 104 and 106 or by any other locking method capable of preventing the carrier from rotating closed.

The guidance rod 403 pivotally attaches to the panels 104 and 106 through eye holes 404 and 406 located at both ends of the guidance rod 403 which connect via guidance bar pins 408 and 410 to holes formed in the lower portion of the panels 104 and 106. The holes are offset from the edges of panels 104 and 106 by a distance x. The distance x is defined by the following equation:

x=0.5(W−0.5r+d)−2r

Where r is the radius of the pin that connects panel 108 to panel 104 and d is the thickness of the material used to make the panels. The pin radius defines the minimum gap between each adjoining panel (herein called the offset pivot), the width of the guidance rod 403 and the length of the offset portions 206 and 218 of the straight pin 202 and the right angle pin 214. In one embodiment consistent with the present invention, the pin radius for the right angle pin, straight pin, the guidance rod pins, the handle, and a U pin used to connect multiple units together, which will be discussed later, are approximately the same.

FIG. 4B depicts one embodiment of the eye holes 404 and 406 located the end portions of the guide bar 402. Each of the eye holes 404 and 406 are separated from the ends of the guide bar 402 by the same distance as the previously defined gap distance r.

In one embodiment consistent with the present invention, each of the eye holes 404 and 406 are formed by two half circles which are separated by a rectangular shape. Consistent with this embodiment, the length and width of the eye hole is defined as 4r, where r is the previously defined gap distance.

In another embodiment consistent with the present invention, the guidance rod 403 fits into a cavity or channel located at the bottom of the base panel 108 such that the guidance bar 403 does not prevent the carrier 100 from closing flat. In another embodiment consistent with the present invention, the guidance rod 403 includes arms which protrude out perpendicular to the guidance rod 403 in such a way as to form a separator for the contents held in the space between the panels.

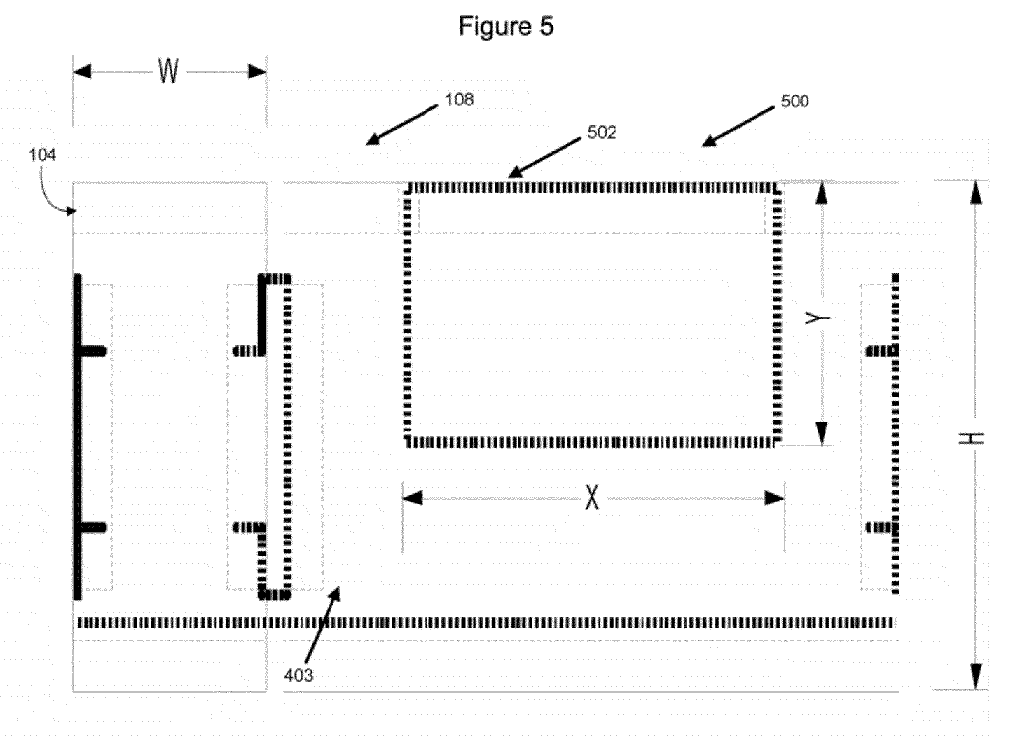

FIG. 5 depicts another embodiment of the carrier device including a handle 500 which is consistent with the present invention. In this embodiment, the handle 500 is rotatively attached to panel 108. The handle 500 has a substantially rectangular shape and is attached to the upper portion of panel 108 by a channel 502. The handle 500 is offset from panels 104 and 106 such that the handle 500 does not interfere with the rotation of the panels 104, 106 and 102 when the carrier is closed. In addition, the handle 500 is shorter then the width of the panel 104 to allow the handle 500 to rotate without obstruction from the panels when the device is open. Accordingly, the depth of the handle Y is related to the width of the handle W by the following equation:

Y=W−4r

where r is the pin radius of at least one of the pins used in the carrying device.

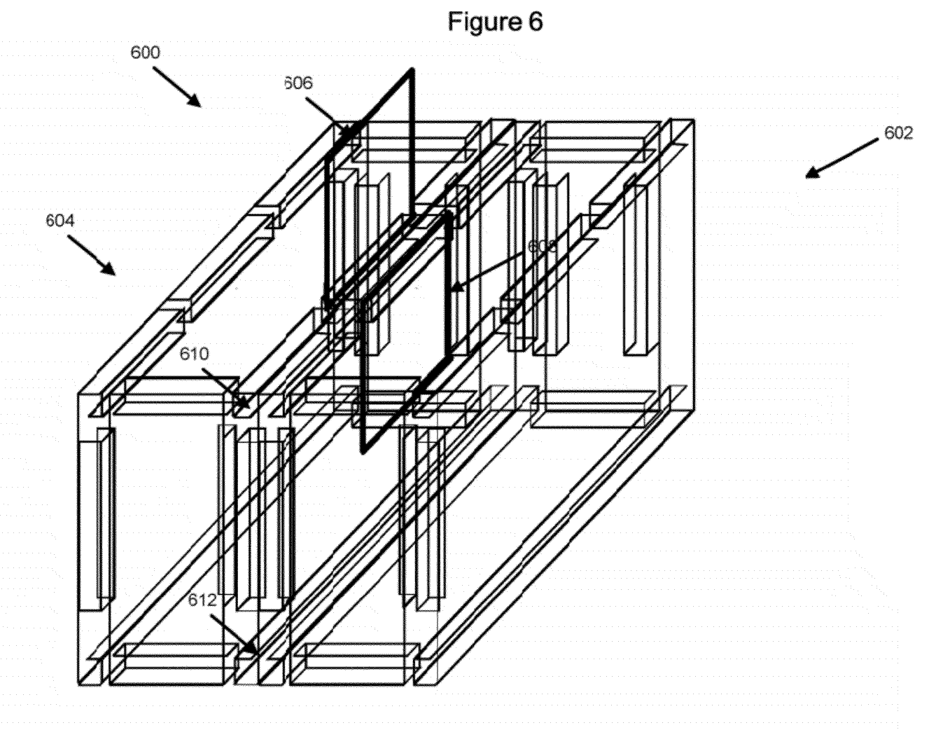

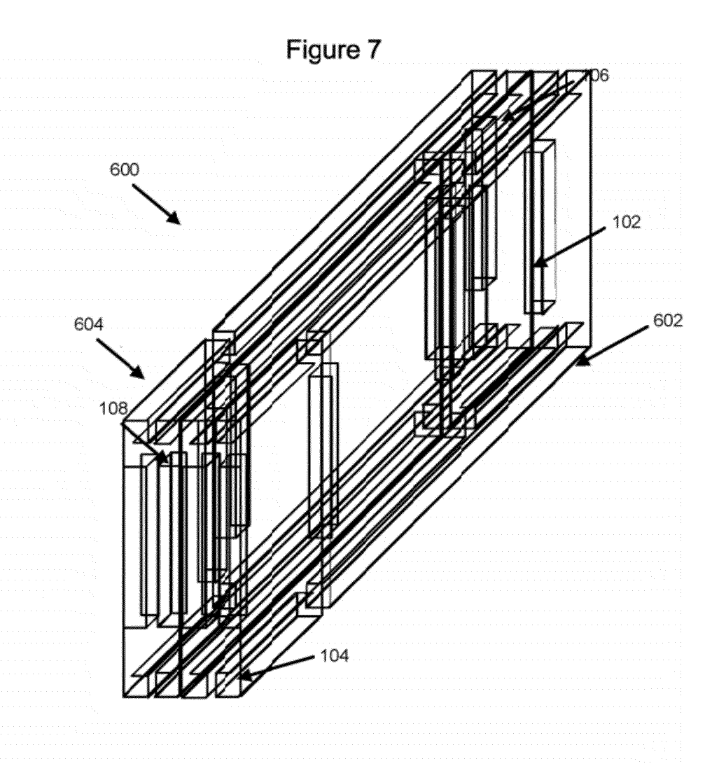

FIG. 6 depicts another embodiment of the present invention where two carrying devices 602 and 604 are adjoined to form a multi chambered carrier 600. In another embodiment, each of the carriers 602 and 604 has a handle 606 and 608 which independently rotate into and out of the open portions of the carriers 602 and 604.

In one embodiment consistent with the present invention, the two carrying devices 602 and 604 are connected to one another by at least four “U” shaped pins 610, 612, 614 and 616 of radius r. The “U” shaped pins are form such that the resemble the letter “U.”

In another embodiment consistent with the present invention, the “U” shaped pins 610 and 614 are positioned in a sleeve created on the upper portion of each base panel such that the upper portions of the two base panels are coupled to one another. In addition, pins 614 and 616 are positioned in sleeves created on the lower portion of each base plate such that the lower portions of the two base plates are coupled together.

FIG. 7 depicts one embodiment of the carrier 600 folded flat. In this embodiment, panels 108 of carriers 602 and 604 lie parallel to one another. Because of this arrangement and the arrangements of the pins, the carrier folds in to an almost flat shape when folded closed. This makes moving and storage of the carrier easier. In addition, the carrier may be used in multiple applications.

In another embodiment consistent with the present invention, the carrier 600 may be used to carry bottles and cans. In another embodiment consistent with the present invention, the carrier 600 may be configured to carry books or compact disks. Because the carrier 600 closes to an almost completely flat shape, it is easily movable. Therefore, a user is able to bring a folded carrier with them to a store or event and open the carrier when an objects needs to be transported.

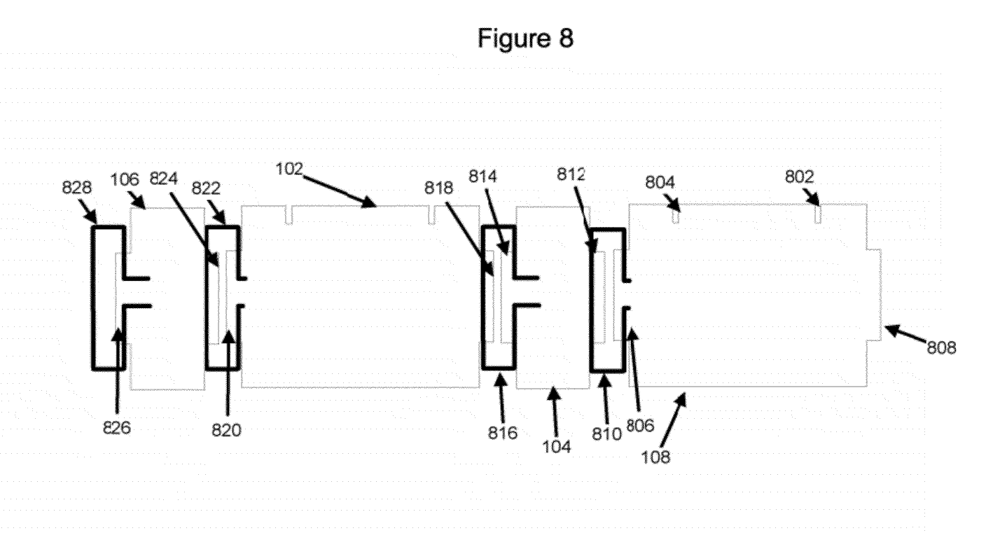

FIG. 8 depicts a method of assembling the carrier. First, the panel 108 is formed by cutting a rectangular sheet of material and cutting the notches 802 and 804 and the tabs 806 and 808. Next, the open portion of a right angle pin 810 is positioned over tab 806. Tab 806 is folded over the open portion of the right angle pin 810 to form a sleeve around the right angle pin 810. The rods protruding from the open portion are parallel to the surface of panel 108 and are in contact with panel 108.

Next, panel 104 is formed by cutting two tabs 812 and 814 into a rectangle shaped piece of material. Tab 812 is positioned under the back portion of the right angle pin 810 and is folded over to form a sleeve around the back portion of the right angle pin 810. The open portion of a straight pin 816 is positioned over the tab 814. The tab 814 is folded over to form a sleeve around the open portion of the straight pin 816. The rods protruding from the straight pin are in contact with the surface of panel 104.

Next, panel 102 is form by cutting the tabs 818 and 820 into another piece of rectangular shaped material. Tab 818 is positioned under the back portion of the straight pin 816. Tab 818 is then folded around the back portion of the straight pin 816 to form a sleeve around the back portion of the pin 818. The open portion of a right angle pin 822 is positioned over the tab 820 which is then folded around the open portion of the right angle pin 822.

Next, panel 106 is formed by cutting notches 824 and 826 into a rectangular shaped material. Tab 824 is positioned under the back portion of the right angle pin 822. Tab 822 is then folded around the back portion of right angle pin 822. Next, the open portion of a straight pin 828 is positioned over tab 826. Tab 826 is then folded around the open portion of straight pin 828 to form a sleeve around the open portion of straight pin 828. The rods extending from the open portion of right pin 828 are parallel to panel 102.

Finally, the back portion of straight pin 828 is positioned over the tab 808. Tab 808 is then folded around the back portion of straight pin 828 to form a sleeve around the back portion of the straight pin 828.

Because the panels of the bottle carrier fold flat, storage and transport of the bottle carrier is simplified. Further, because of the rigidity of the carrier, the carrier is capable of carrying numerous items having a high weight. In addition, the carrier may be used repeatedly. This reduces the amount of waste materials which are normally encountered in the production of disposable carriers. Because the handle folds inward and there are no bottom extrusions when folded flat, the carrier is able to fold into a compact form. because the carrier includes the offset pivots, the carrier opens to a uniform and predictable shape. In addition, since the carrier folds laterally, gravity does not force the device opened thereby allowing for vertical, side by side, storage.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A carrying device comprising:
a first panel having a first end and a second end;
a second panel having a first end and a second end with one end rotatively coupled to one end of the first panel,
a third panel having a first end and a second end with one end rotatively coupled to the other end of the second panel;
a fourth panel having a first end and a second end with one end rotatively coupled to the other end of the third panel and the other end rotatively coupled to the other end of first panel.

2. The carrying device of claim 1, wherein a right angle pin connects the first panel to the fourth panel and restricts the rotation of the fourth panel such that an angle between the first panel and fourth panel is between 0 and 90 degrees.

3. The carrying device of claim 1, wherein a straight angle pin connects the first panel to the second panel and restricts the rotation of the second panel such that an angle between the first panel and second panel is between 0 and 180 degrees.

4. The carrying device of claim 1, wherein a right angle pin connects the second panel to the third panel and restricts the rotation of the third panel such that an angle between the second panel and third panel is between 0 and 90 degrees.

5. The carrying device of claim 1, wherein a straight angle pin connects the third panel to the fourth panel and restricts the rotation of the fourth panel such that an angle between the third panel and fourth panel is between 0 and 180 degrees.

6. The carrying device of claim 1, wherein the second, third and fourth panels rotate around the base panel such that the second panel is in the same plane as the first panel and the third and fourth panels are at least on of the first panel and second panel.

7. The carrying device of claim 1, further comprising a handle rotatively connected to a top edge of the first panel.

8. The carrying device of claim 1, further comprising a guide unit rotatively coupled to a lower portion of the second and a lower portion of the fourth panel.

9. The carrying device of claim 7, wherein the guide unit includes at least two rods which are rotatablly connected to the guide unit.

10. The carrying unit of claim 7, wherein the guide unit fits into a recess in the first panel when the carrying device is closed.

11. A method of manufacturing a carrying device comprising the steps of:
rotatively coupling one end of a first panel to one end of a second panel,
rotatively coupling the other end of the second panel with one end of a third panel;
rotatively coupling the other end of the third panel to one end of a fourth panel; and
rotatively coupling the other end of the fourth panel to the other end of the first panel.
The carrying device of claim 11, wherein a right angle pin connects the first panel to the fourth panel and restricts the rotation of the fourth panel such that an angle between the first panel and fourth panel is between 0 and 90 degrees.

12. The carrying device of claim 11, wherein a straight angle pin connects the first panel to the second panel and restricts the rotation of the second panel such that an angle between the first panel and second panel is between 0 and 180 degrees.

13. The carrying device of claim 11, wherein a right angle pin connects the second panel to the third panel and restricts the rotation of the third panel such that an angle between the second panel and third panel is between 0 and 90 degrees.

14. The carrying device of claim 11, wherein a straight angle pin connects the third panel to the fourth panel and restricts the rotation of the fourth panel such that an angle between the third panel and fourth panel is between 0 and 180 degrees.

15. The carrying device of claim 11, wherein the second, third and fourth panels rotate around the base panel such that the second panel is in the same plane as the first panel and the third and fourth panels are at least on of the first panel and second panel.

16. The carrying device of claim 11, further comprising a handle rotatively connected to a top edge of the first panel.

17. The carrying device of claim 11, further comprising a guide unit rotatively coupled to a lower portion of the second and a lower portion of the fourth panel.

18. The carrying device of claim 17, wherein the guide unit includes at least two rods which are rotatablly connected to the guide unit.

19. The carrying unit of claim 17, wherein the guide unit fits into a recess in the first panel when the carrying device is closed.
